(19) United States
(12) Patent Application Publication
(10) Pub. No.: US 2025/0254691 A1
(43) Pub. Date: Aug. 7, 2025

(54) MULTI-SCELL ACTIVATION

(71) Applicant: Nokia Technologies Oy, Espoo (FI)

(72) Inventors: Lei DU, Beijing (CN); Lars DALSGAARD, Oulu (FI); Yue Ji CHEN, Zhejiang (CN)

(73) Assignee: Nokia Technologies Oy, Espoo (FI)

(21) Appl. No.: 18/857,658

(22) PCT Filed: Apr. 22, 2022
(86) PCT No.: PCT/CN2022/088605

§ 371 Date: Oct. 17, 2024

(51) Int. Cl. H04W 72/21; H04B 7/06; H04W 56/00; H04W 72/56

(52) U.S. Cl. CPC H04W 72/21; H04B 7/0626; H04W 56/0045; H04W 72/56

(57) ABSTRACT

Example embodiments of the present disclosure relate to devices, methods, apparatuses and computer readable storage media for activation of multiple SCells. In example embodiments, a terminal device receives, from a network device, an instruction to activate a plurality of secondary cells including a physical uplink control channel, PUCCH, secondary cell. The PUCCH secondary cell is configured with a PUCCH. Then, the terminal device determines, from within the plurality of secondary cells, one or more secondary cells associated with a primary cell and one or more secondary cells associated with the PUCCH secondary cell. Moreover, the terminal device prioritizes activation of the one or more secondary cells associated with the primary cell over activation of the one or more secondary cells associated with the PUCCH secondary cell.

### FIELD

Example embodiments of the present disclosure generally relate to the field of communications, and in particular, to devices, methods, apparatuses and computer readable storage media for activation of multiple secondary cells (SCells). This is also applied when a primary secondary SCell (PSCell) is one of the multiple SCells.

### BACKGROUND

In some cases where a physical uplink control channel (PUCCH) on a primary cell (PCell) is overloaded, additional PUCCH resources may be configured on a certain SCell, which is called a PUCCH SCell. In these cases, some SCells may be configured to use the PUCCH or uplink transmission on the PCell, while other SCells may be configured to use the PUCCH or uplink transmission on the PUCCH SCell. Thus, it also can be considered that some SCells are associated with the PCell, while the other SCells are associated with the PUCCH SCell. For example, for power consumption, a plurality of SCells may be deactivated. When the plurality of SCells are instructed to be activated, if cell detection is required for some of the plurality of SCells, these SCells will equally compete during the cell detection phase. However, different activation orders for the plurality of SCells may cause different activation delays. Thus, among others open issues, how to determine an appropriate activation order for the plurality of SCells is still an open issue to be addressed.

### SUMMARY

In general, example embodiments of the present disclosure provide devices, methods, apparatuses and computer readable storage media for activation of multiple SCells.

In a first aspect, a terminal device is provided which comprises at least one processor and at least one memory including computer program code. The at least one memory and the computer program code are configured to, with the at least one processor, cause the terminal device to receive, from a network device, an instruction to activate a plurality of secondary cells including a physical uplink control channel, PUCCH, secondary cell, the PUCCH secondary cell being configured with a PUCCH. Then, the terminal device is caused to determine, from within the plurality of secondary cells, one or more secondary cells associated with a primary cell and one or more secondary cells associated with the PUCCH secondary cell. Moreover, the terminal device is caused to prioritize activation of the one or more secondary cells associated with the primary cell over activation of the one or more secondary cells associated with the PUCCH secondary cell.

In a second aspect, a network device is provided which comprises at least one processor and at least one memory including computer program code. The at least one memory and the computer program code are configured to, with the at least one processor, cause the network device to transmit, to a terminal device, an indication associated with a plurality of secondary cells including a physical uplink control channel, PUCCH, secondary cell, the PUCCH secondary cell being configured with a PUCCH, the indication indicating that one or more secondary cells of the plurality of secondary cells are associated with a primary cell and/or one or more secondary cells of the plurality of secondary cells are associated with the PUCCH secondary cell.

In a third aspect, a method is provided. In the method, a terminal device receives, from a network device, an instruction to activate a plurality of secondary cells including a physical uplink control channel, PUCCH, secondary cell, the PUCCH secondary cell being configured with a PUCCH. Then, the terminal device determines, from within the plurality of secondary cells, one or more secondary cells associated with a primary cell and one or more secondary cells associated with the PUCCH secondary cell. Moreover, the terminal device prioritizes activation of the one or more secondary cells associated with the primary cell over activation of the one or more secondary cells associated with the PUCCH secondary cell.

In a fourth aspect, a method is provided. In the method, a network device transmits, to a terminal device, an indication associated with a plurality of secondary cells including a physical uplink control channel, PUCCH, secondary cell, the PUCCH secondary cell being configured with a PUCCH, the indication indicating that one or more secondary cells of the plurality of secondary cells are associated with a primary cell and/or one or more secondary cells of the plurality of secondary cells are associated with the PUCCH secondary cell

In a fifth aspect, there is provided an apparatus comprising means for performing the method according to the third aspect or fourth aspect.

In a sixth aspect, there is provided a computer readable storage medium comprising program instructions stored thereon. The instructions, when executed by a processor of a device, cause the device to perform the method according to the third aspect or fourth aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example multi-SCell activation process with cell detection phase;

FIG. 2 illustrates an example environment in which example embodiments of the present disclosure can be implemented;

FIG. 3 illustrates a signaling flow between the terminal device and the network device according to some example embodiments of the present disclosure;

FIG. 4 illustrates a flowchart of an example process for multi-SCell activation according to some example embodiments of the present disclosure;

FIG. 5 illustrates a flowchart of an example method according to some example embodiments of the present disclosure; and

FIG. 6 illustrates a flowchart of an example method according to some other example embodiments of the present disclosure; and

FIG. 7 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device via which services can be provided to a terminal device in a communication network. As an example, the network device may comprise a base station. As used herein, the term “base station” (BS) refers to a network device via which services can be provided to a terminal device in a communication network. The base station may comprise any suitable device via which a terminal device or UE can access the communication network. Examples of the base stations include a relay, an access point (AP), a transmission point (TRP), a node B (NodeB or NB), an evolved NodeB (eNodeB or eNB), a New Radio (NR) NodeB (gNB), a Remote Radio Module (RRU), a radio header (RH), a remote radio head (RRH), a low power node such as a femto, a pico, and the like.

As used herein, the term “terminal device” or “user equipment” (UE) refers to any terminal device capable of wireless communications with each other or with the base station. The communications may involve transmitting and/or receiving wireless signals using electromagnetic signals, radio waves, infrared signals, and/or other types of signals suitable for conveying information over air. In some example embodiments, the UE may be configured to transmit and/or receive information without direct human interaction. For example, the UE may transmit information to the base station on predetermined schedules, when triggered by an internal or external event, or in response to requests from the network side.

Examples of the user device include, but are not limited to, smart phones, wireless-enabled tablet computers, laptop-embedded equipment (LEE), laptop-mounted equipment (LME), wireless customer-premises equipment (CPE), sensors, metering devices, personal wearables such as watches, and/or vehicles that are capable of communication. For the purpose of discussion, some example embodiments will be described with reference to UEs as examples of the terminal devices, and the terms “terminal device” and “user equipment” (UE) may be used interchangeably in the context of the present disclosure.

As used herein, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular base station, or other computing or base station.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the terms “first”, “second” and the like may be used herein to describe various elements, these elements should not be limited by these terms. These terms are only used to distinguish one element from another. For example, a first element could be referred to as a second element, and similarly, a second element could be termed a first element, without departing from the scope of example embodiments. As used herein, the term “and/or” includes any and all combinations of one or more of the listed terms.

In long-term evolution (LTE) and fifth generation (5G) new radio (NR), a SCell can be activated or deactivated. The transition between an activated status and a deactivated status is mainly based on a media access control (MAC) control elements (CE) command from the network, for example, the SCell activation/deactivation commands. It can also be triggered by a Radio Resource Control (RRC) message or downlink control information (DCI)-based indication. When the UE activates a deactivated SCell, it is required to do so within the activation delay Tactivation_time to transition from the deactivated status to the activated status.

In the third generation partnership project (3GPP), there are some discussion about delay requirements within which the UE shall be able to activate a deactivated downlink (DL) SCell, for example,

$$n + \frac{{T}_{HARQ} + {T}_{activation\_time} + {T}_{CSI\_Reporting}}{NR slot length} ,$$

where T_{HARQ} IS the time for transmission of acknowledge for the MAC CE command, and the T_{CSI_Reporting} is the time for channel state information (CSI) reporting.

Further, in the 3GPP release 16 (Rel-16) and release 17 (Rel-17), there are some discussions about SCell activation delay for activating multiple downlink SCells among which one SCell is the PUCCH SCell. For example, the SCell activation delay requirement with multiple DL SCells has been defined in Rel-16 assuming the multiple SCells are being activated in a single MAC command. The delay extension due to interruption among the multiple being-activated SCells has been considered, for the reason that the activation of one SCell may be interrupted or delayed by the activation of other in-parallel being-activated SCells as the cell detection including e.g. RF retuning and/or adaptive gain control (AGC) settling in respective SCells (if needed) needs to be handled in sequence. In Rel-16, all the being-activated SCells are of the same priority to perform cell detection, hence activation of one SCell may be delayed by all the other being-activated SCells in the worse case.

It is also discussed that “cell detection time” in delay extension due to searcher limitation is “1*Tᵣₛ” for one frequency range 1 (FR1) unknown SCell and “8*Tᵣₛ” for one frequency range 2 (FR2) unknown SCell. For instance, if N1 parallel SCells to-be-activated are unknown requiring cell detection and belong to FR1, the activation delay will be extended by N1*Tᵣₛ. In this case, the total activation time can be denoted as:
T_{activation_time_multiple_scells} IS:
   −6 ms+T_{FirstSSB_MAX_multiple_scells}+T_{SMTC_MAX_multiple_scells}+Tᵣₛ*N₁+T_{L1-RSRP,measure}+T_{L1-RSRP,report}+T_{HARQ}+max(T_{uncertainty_MAC_multiple_scells}+T_{FineTiming}+2 ms, T_{uncertainty_SP_multiple_scells}), if semi-persistent CSI-RS is used for CSI reporting,
   3 ms+T_{FirstSSB_MAX_multiple_scells}+T_{SMTC_MAX_multiple_scells}+Tᵣₛ*N₁+T_{L1-RSRP,measure}+T_{L1-RSRP,report}+max (T_{HARQ}+T_{uncertainty_MAC_multiple_scells}+5 ms+T_{FineTiming}, T_{uncertainty_RRC_multiple_scells}+T_{RRC_delay}), if periodic CSI-RS is used for CSI reporting.
otherwise, T_{FirstSSB_MAX_multiple_scells}+T_{SMTC_MAX_multiple_scells}+Tᵣₛ*N₁+Tᵣₛ+5 ms

For instance, if N2 parallel SCells to-be-activated are unknown requiring cell detection and belong to FR2, the activation delay may be further extended by N2*8*Tᵣₛ, as beam sweeping on one SCell will take 8*Tᵣₛ. This will significantly increase the activation delay for the FR2 SCells. In this case, the total activation time can be denoted as:

$$( {T}_{FirstSSB\_Max} + {T}_{SMTC\_MAX} ) + {T}_{r s} * {N}_{1} + 8 * {T}_{rs} * {N}_{s} + {T}_{rs} + 5 ms$$

As described above, when the PUCCH SCell is being activated together with other SCells, the network may activate additional PUCCH resources on the PUCCH SCell, for example, for the reason that the PUCCH on PCell is overloaded or for other reasons. Among the other SCells to be activated, some of the SCells may be configured to use the PUCCH on PCell while others may be configured to use the PUCCH on PUCCH SCell.

All the SCells including the PUCCH SCell will equally compete during the cell detection phase. For the SCells associated with PCell, the UE is able to transmit the valid CSI report on the PCell at the end of activation. However, for the SCells associated with PUCCH SCell, even if they succeed in the cell detection phase, the UE would have to wait until the activation of the PUCCH SCell and the uplink (UL) on the PUCCH SCell, as the CSI reports need to be sent on the PUCCH SCell as the ending point of PUCCH SCell activation. Therefore, for the SCells associated with the PUCCH SCell, the preemption during cell detection phase does not help complete the activation of the SCells, meanwhile it would further unnecessarily extend the activation delay of other SCells associated with PCell.

Further, there has been the proposal to prioritize the PUCCH SCell activation over other being-activated SCells. This helps to minimize the activation delay of the PUCCH SCell, however, the above problem is still valid on the other SCells being associated to the PCell.

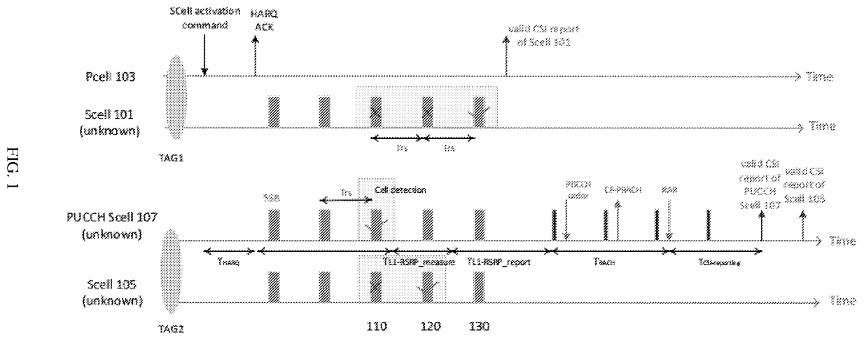

FIG. 1 illustrates an example multi-SCell activation process with cell detection phase. As shown in FIG. 1, the SCell 101 is in the same (timing advance group) TAG 1 as the PCell 103 and the SCell 105 is in the same TAG 2 as the PUCCH SCell 107. All the SCells being activated are assumed unknown, so cell detection is needed for each of the SCells during activation.

When activating the multiple SCells as shown in FIG. 1, the PUCCH SCell 107 is prioritized during cell detection phase and the UE can continue with the beam measurements and random access to acquire the uplink timing. The SCell 105 then succeeds in cell detection phase when competing with the SCell 103 and is ready to transmit CSI report. However, as the SCell 105 is in the same TAG of the PUCCH SCell 107, it is not able to transmit CSI report as the uplink of the PUCCH SCell 107 is not activated. Hence the CSI report of the SCell 105 is delayed until the end of the activation of the PUCCH SCell 107. Meanwhile, the activation of the SCell 101 is extended by 2*Tᵣₛ (for FR1) or 2*8*Tᵣₛ (for FR2) due to the interruption from the PUCCH SCell 107 and the SCell 105, otherwise it could have been activated before the SCell 105 if it succeeds in cell detection phase when competing with the SCell 105 and the PUCCH SCell 107.

It can be seen that the unsuitable activation order for activation of multiple SCells may cause the extra activation delay. Thus, there is a need to avoid unnecessary delay extension especially from the SCells associated with the PUCCH SCell. Besides, by now, there is no effective way to determine an appropriate activation order for the multiple SCells to further improve transmission efficiency.

Example embodiments of the present disclosure provide a scheme of activation of multiple SCells. With the scheme, a device, such as a UE, receives, from another device, such as a network device, an instruction to activate a plurality of SCells including a PUCCH SCell. The PUCCH SCell is configured with a PUCCH. Then, the UE determines, from within the plurality of SCells, one or more SCells associated with a PCell and one or more SCells associated with the PUCCH SCell. Moreover, the UE prioritizes activation of the one or more SCells associated with the PCell over activation of the one or more SCells associated with the PUCCH SCell.

This scheme reduces activation delay by avoiding unnecessary delay extension especially from the SCells associated with the PUCCH SCell. As such, it is allowed to improve transmission efficiency.

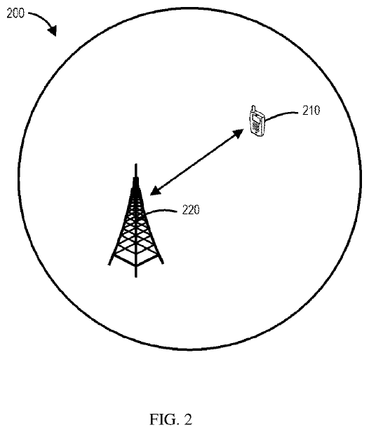

FIG. 2 shows an example environment 200 in which example embodiments of the present disclosure can be implemented.

The environment 200, which may be a part of a communication network, comprises two devices 210 and 220 communicating with each other or with other devices via each other.

The devices 210 and 220 may be implemented by any suitable devices in the communication network. In some example embodiments, the device 210 may be implemented by a terminal device and the device 220 may be implemented by a network device, or vice versa. In some other example embodiments, the devices 210 and 220 may be both implemented by terminal devices or network devices. Just for the purpose of discussion, in this example, the terminal device will be taken as an example of the device 210, and the network device will be taken as an example of the device 220.

It is to be understood that two devices are shown in the environment 200 only for the purpose of illustration, without suggesting any limitation to the scope of the present disclosure. In some example embodiments, the environment 200 may comprise a further device to communicate with the device 210 and the device 220. In some example embodiments, the device 210 may be connected to a plurality cells including a PCell and one or more SCells under the control of the device 220.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

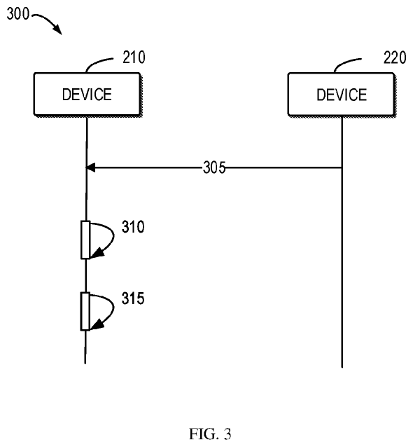

FIG. 3 shows a flowchart of an example method 300 according to some example embodiments of the present disclosure. The method 300 can be implemented by the device 210 as shown in FIG. 2. For the purpose of discussion, the method 300 will be described with reference to FIG. 2.

As shown in FIG. 3 the device 220 transmits (305), to the device 210, an instruction to activate a plurality of SCells including a PUCCH SCell. The PUCCH SCell is configured with a PUCCH. For example, the instruction may be carried in a MAC command, or a RRC signaling, or some other signaling.

Then, the device 210 determines (310), from within the plurality of SCells, one or more SCells associated with a PCell and one or more SCells associated with the PUCCH SCell.

In some example embodiments, the device 210 may determines if cell detection is required for the plurality of SCells to-be-activated. For example, the cell detection may be required if a SCell is unknown in FR1 and non-contiguous to any of the serving cells or if a SCell is unknown in FR2 and the first cell to be activated in a band. For the SCells where cell detection is required, the device 210 may group these SCells based on their associations with the PCell and the PUCCH SCell. For example, the device 210 may determine that cell detection is required for activating one or more SCells associated with the PCell and one or more SCells associated with the PUCCH SCell. Then, on this basis, the device 210 may determine the one or more SCells associated with the PCell and the one or more SCells associated with the PUCCH SCell.

In some example embodiments, the device 210 may determine that one SCell is associated with the PCell or the PUCCH SCell based on a timing advance group configuration. For example, if the device 210 determines that the SCell is in the same timing advance group as the PCell, it may determine that SCell is associated with the PCell. As an example, if the device 210 determines that the tag-id of the SCell is the same as the tag-id of the PCell, it may determine that the SCell is associated with the PCell. Likewise, for example, if the device 210 determines that the SCell is in the same timing advance group as the PUCCH SCell, it may determine that the SCell is associated with the PUCCH SCell. As an example, if the device 210 determines that the tag-id of the SCell is the same as the tag-id of the PUCCH SCell, it may determine that the SCell is associated with the PUCCH SCell.

In some example embodiments, the device 210 may determine that one SCell is associated with the PCell or the PUCCH SCell based on a CSI reporting resources configuration. For example, if the device 210 determines that CSI reporting resources for the SCell are configured on the PCell, for example based on the csi-reportconfig parameter, it may determine that the SCell is associated with the PCell. Likewise, for example, if the device 210 determines that CSI reporting resources for the SCell are configured on the PUCCH SCell, for example based on the csi-reportconfig parameter, it may determine that the SCell is associated with the PUCCH SCell.

In some example embodiments, the device 210 may receive an indication indicating that one or more SCells of the plurality of SCells are associated with the PCell and/or one or more SCells of the plurality of SCells are associated with the PUCCH SCell. In this case, the device 210 may determine that one SCell is associated with the PCell or the PUCCH SCell based on the indication. For example, the above indication and the instruction to activate the plurality of SCells may be carried in the same signaling, such as a MAC command. Alternatively or in addition, the indication may be transmitted before, for example in the serving cell configuration from the device 120. As another example, the indication may comprise the instruction to activate the plurality of secondary cells.

In some example embodiments, the device 210 may determine that one SCell is associated with the PCell or the PUCCH SCell based on collocation information. For example, if the device 210 determines that the SCell is collocated with the PCell, it may determine that the SCell is associated with the PCell. Likewise, if the device 210 determines that the SCell is collocated with the PUCCH SCell, it may determine that the SCell is associated with the PUCCH SCell. The collocation information can be determined based on the receive timing difference between the SCell and PCell or PUCCH SCell at the UE, and/or based on the network information. For instance, the device 210 determine that the SCell is collocated with the PCell if the receive timing difference between the SCell and PCell is less than a threshold. Likewise, the device 210 determine that the SCell is collocated with the PUCCH SCell if the receive timing difference between the SCell and PUCCH SCell is less than a threshold.

In some example embodiments, the device 210 may determine that one SCell is associated with the PCell or the PUCCH SCell based on a carrier aggregation configuration. For example, if the device 210 determines that the SCell is intra-band or in the same band with the PCell based on the carrier aggregation configuration, it may determine that the SCell is associated with the PCell. Likewise, if the device 210 determines that the SCell is intra-band with the PUCCH SCell based on the carrier aggregation configuration, it may determine that the SCell is associated with the PUCCH SCell.

In some example embodiments, if the device 210 determines that the SCell is associated with the PCell, the PUCCH or uplink transmission for the SCell will be transmitted on the PCell after the SCell is activated. If the device 210 determines that the SCell is associated with the PUCCH SCell, the PUCCH or uplink transmission for the SCell will be transmitted on the PUCCH SCell after the SCell is activated.

As shown in FIG. 3, the device 210 prioritizes (315) activation of the one or more SCells associated with the PCell over activation of the one or more SCells associated with the PUCCH SCell.

In some example embodiments, the device 210 may prioritize activation of the PUCCH SCell over the activation of the one or more SCells associated with the PCell. In this case, the device 210 may activate the PUCCH SCell first, then the one or more SCells associated with the PCell, and finally the one or more SCells associated with the PUCCH SCell. The cell detection of the one or more SCells associated with the PUCCH SCell may be performed in parallel with the follow-up steps of PUCCH SCell activation, for example, beam measurement and/or random access procedure on the PUCCH SCell.

In some example embodiments, the device 210 may prioritize the activation of the one or more SCells associated with the PCell over activation of the PUCCH SCell and prioritize the activation of the PUCCH SCell over the activation of the one or more SCells associated with the PUCCH SCell. In this case, the device 210 may activate the one or more SCells associated with the PCell first, then the PUCCH SCell, and finally the one or more SCells associated with the PUCCH SCell. For example, after the cell detection of PUCCH SCell, the device 210 may activate these one or more SCells associated with PUCCH SCell in parallel with beam measurement and/or random access procedure on the PUCCH SCell. In this case, the CSI reports of the PUCCH SCell and the one or more SCells associated with the PUCCH SCell may be transmitted on the PUCCH SCell at the end of PUCCH SCell activation.

In some example embodiments, an activation delay for activating the one or more SCells associated with the PCell may only be based on the number of the one or more SCells associated with the PCell, and an activation delay for activating the one or more SCells associated with the PUCCH SCell may be based on: the number of the one or more SCells associated with the PCell, and the number of the one or more SCells associated with the PUCCH SCell, and an activation delay for activating the PUCCH SCell.

For example, the activation delay for activating one or more SCells associated with the PCell may be extended by Tᵣₛ*X1. As an example, the activation delay for activating the one or more SCells associated with the PCell may be represented as:
−6 ms+T_{FirstSSB_MAX_multiple_scells}+T_{SMTC_MAX_multiple_scells}+Tᵣₛ*X₁+8*Tᵣₛ*Y₁+T_{L1-RSRP,measure}+T_{L1-RSRP,report}+T_{HARQ}+max(T_{uncertainty_MAC_multiple_scells}+T_{FineTiming}++2 ms, T_{uncertainty_SP_multiple_scells}), if semi-persistent CSI-RS is used for CSI reporting,
3 ms+T_{FirstSSB_MAX_multiple_scells}+T_{SMTC_MAX_multiple_scells}+Tᵣₛ*X₁+8*Tᵣₛ*Y₁+T_{L1-RSRP,measure}+T_{L1-RSRP,report}+max (T_{HARQ}+T_{uncertainty_MAC_multiple_scells}+5 ms+T_{FineTiming}, T_{uncertainty_RRC_multiple_scells}+T_{RRC_delay}), if periodic CSI-RS is used for CSI reporting.
otherwise, T_{FirstSSB_MAX_multiple_scells}+T_{SMTC_MAX_multiple_scells}+Tᵣₛ*X₁+8*Tᵣₛ*Y₁+Tᵣₛ+5 ms
   where Tᵣₛ is cell detection time for one FR1 SCell and 8*Tᵣₛ is cell detection time for one FR2 SCell, X1 is the number of parallel FR1 unknown to-be-activated SCells requiring cell detection associated with the PCell, and X2 is the number of parallel FR1 unknown to-be-activated SCells requiring cell detection associated with the PUCCH SCell, Y₁ is the number of parallel FR2 unknown to-be-activated SCells associated with the PCell, and Y₂ is the number of parallel FR2 unknown to-be-activated SCells associated with the PUCCH SCell.

And the activation delay for activating the one or more SCells associated with the PUCCH SCell may be represented as:

$$Max ( {T}_{delay\_PUCCH \_SCell} , {T}_{activation\_time} + {T}_{r s} * ( {X}_{1} + {X}_{2} ) + 8 * {T}_{r s} * ( {Y}_{1} + {Y}_{2} ) )$$

where T_{delay_PUCCH SCell} is activation time for activating the PUCCH SCell, and T_{activation_time} is activation time for activating one DL SCell.

And the activation delay for activating the one or more SCells associated with the PCell may be represented as:

$${T}_{activation\_time} + {T}_{r s} * {X}_{1} + 8 * {T}_{r s} * {Y}_{1}$$

where T_{delay_PUCCH SCell} is activation time for activating the PUCCH SCell, and T_{activation_time} is activation time for activating one DL SCell.

For example, the above principle may apply when the PUCCH SCell to be activated is in the same FR as the PCell. Otherwise such prioritization determination for activation may not be applied.

In this way, the activation of SCells associated with the PCell can be finalized earlier without interruption from SCells associated with the PUCCH SCell. As such, it is allowed to improve transmission efficiency.

It is to be understood that PSCell activation may in many aspects reflect the same challenges described and solutions applicable to when the PUCCH SCell is being activated together with other SCells. Hence, the problems and solutions described for the PUCCH SCell activation together with other SCells can also be applied for PSCell activation when activated together with other SCell.

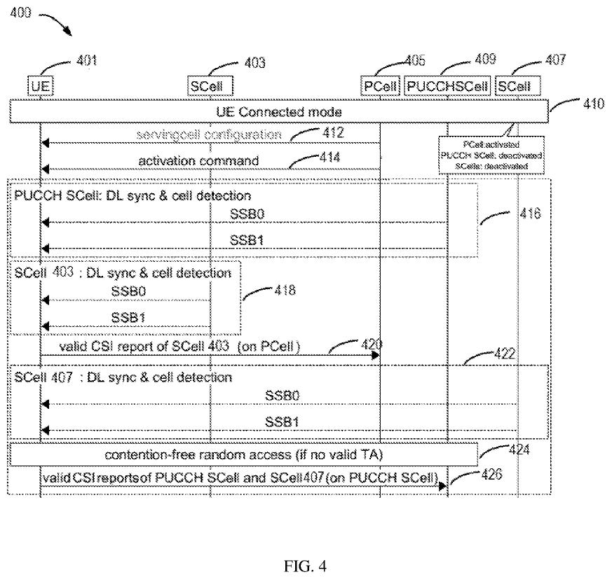

FIG. 4 illustrates a flowchart of an example process 400 for multi-SCell activation according to some example embodiments of the present disclosure. In this example, the device 210 is implemented by the UE 401. The SCell 403 is associated with the PCell 405, and the SCell 407 is associated with the PUCCH SCell 409.

At 410, the UE 410 is configured with the SCell 403, the PCell 405, the SCell 407 and the PUCCH SCell 409 in connected mode. The PCell 405 is activated, and the SCells 403 and 407 and the PUCCH SCell 409 are deactivated. All the SCells are assumed to be unknown, that is, cell detection is required.

At 412, the UE 410 receives a serving cell configuration, which may indicate timing advance group and/or CSI reporting resources and other configuration information for example. At 414, the UE 410 receives an activation command to activate the SCells 403 and 407 and the PUCCH SCell 409.

As an example, in the serving cell configuration, the network may indicate that the SCell 403 is associated with the PCell 405 on PUCCH and the SCell 407 is associated with the PUCCH SCell 409. Alternatively or in addition, the UE 410 may determine PUCCH association, that is, whether a SCell is associated with the PCell 405 or the PUCCH SCell 409, based on the TAG or CSI reporting resources configuration. Then, the UE 401 may activate the SCells based on the PUCCH association.

At 416, the PUCCH SCell 409 is firstly started to be activated. The downlink synchronization and the cell detection for the PUCCH SCell 409 is performed.

Then, at 418, the SCell 403 is started to be activated. The downlink synchronization and the cell detection for the SCell 403 is performed. At 420, the CSI report of the SCell 403 is transmitted on the PCell 405. Thus, activation of the SCell 403 is finalized.

At 422, the SCell 407 is started to be activated. The downlink synchronization and the cell detection for the SCell 407 is performed. At 424, if there is no valid TA for PUCCH SCell 409, the contention-free random access is performed. For example, after the cell detection on the PUCCH SCell 409, the UE 401 may continue beam measurement and/or random access procedure in parallel with the cell detection on other SCells. Then, at 426, the CSI reports of the SCell 407 and the PUCCH SCell 409 are transmitted on the PUCCH SCell 409. Thus, activations of the SCell 407 and the PUCCH SCell 409 are finalized.

All operations and features as described above with reference to FIGS. 2-3 are likewise applicable to the process 400 and have similar effects. For the purpose of simplification, the details will be omitted.

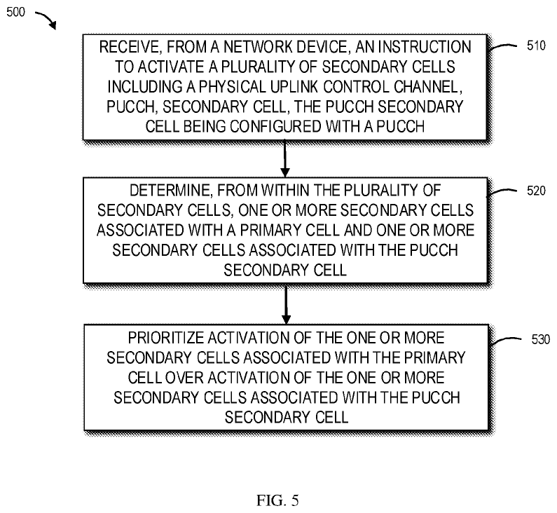

FIG. 5 shows a flowchart of an example method 500 according to some example embodiments of the present disclosure. The method 500 can be implemented by the device 210 as shown in FIG. 2. For the purpose of discussion, the method 500 will be described with reference to FIG. 2.

As shown in FIG. 5, at block 510, the device 210 receives, from the device 220, an instruction to activate a plurality of secondary cells including a physical uplink control channel, PUCCH, secondary cell, the PUCCH secondary cell being configured with a PUCCH. At block 520, the device 210 determines, from within the plurality of secondary cells, one or more secondary cells associated with a primary cell and one or more secondary cells associated with the PUCCH secondary cell. At block 530, the device 210 prioritizes activation of the one or more secondary cells associated with the primary cell over activation of the one or more secondary cells associated with the PUCCH secondary cell.

In some example embodiments, the device 210 may determine that cell detection is required for activating the one or more secondary cells associated with the primary cell and the one or more secondary cells associated with the PUCCH secondary cell.

In some example embodiments, the device 210 may determine that one secondary cell is associated with the primary cell based on at least one of: a determination that the secondary cell is in the same timing advance group as the primary cell; a determination that channel state information reporting resources for the secondary cell are configured on the primary cell; an indication from the device 220 indicating that the secondary cell is associated with the primary cell; a determination that the secondary cell is collocated with the primary cell; or a determination that the secondary cell is intra-band with the primary cell based on a carrier aggregation configuration.

In some example embodiments, in accordance with a determination that the secondary cell is be associated with the primary cell, the uplink transmission for the secondary cell may be transmitted on the primary cell after the secondary cell is activated.

In some example embodiments, the device 210 may determine that one secondary cell is associated with the PUCCH secondary cell based on at least one of: a determination that the secondary cell is in the same timing advance group as the PUCCH secondary cell; a determination that channel state information reporting resources for the secondary cell are configured on the PUCCH secondary cell; an indication from the device 220 indicating that the secondary cell is associated with the PUCCH secondary cell; a determination that the secondary cell is collocated with the PUCCH secondary cell; or a determination that the secondary cell is intra-band with the PUCCH secondary cell based on a carrier aggregation configuration.

In some example embodiments, in accordance with a determination that the secondary cell is determined to be associated with the PUCCH secondary cell, uplink transmission for the secondary cell may be transmitted on the PUCCH secondary cell after the secondary cell is activated.

In some example embodiments, the device 210 may prioritize activation of the PUCCH secondary cell over the activation of the one or more secondary cells associated with the primary cell.

In some example embodiments, the device 210 may prioritize the activation of the one or more secondary cells associated with the primary cell over activation of the PUCCH secondary cell; and prioritize the activation of the PUCCH secondary cell over the activation of the one or more secondary cells associated with the PUCCH secondary cell.

In some example embodiments, an activation delay for activating the one or more secondary cells associated with the primary cell is only based on the number of the one or more secondary cells associated with the primary cell; and an activation delay for activating the one or more secondary cells associated with the PUCCH secondary cell is based on: the number of the one or more secondary cells associated with the primary cell, and the number of the one or more secondary cells associated with the PUCCH secondary cell, and an activation delay for activating the PUCCH secondary cell.

All operations and features as described above with reference to FIGS. 2-4 are likewise applicable to the method 500 and have similar effects. For the purpose of simplification, the details will be omitted.

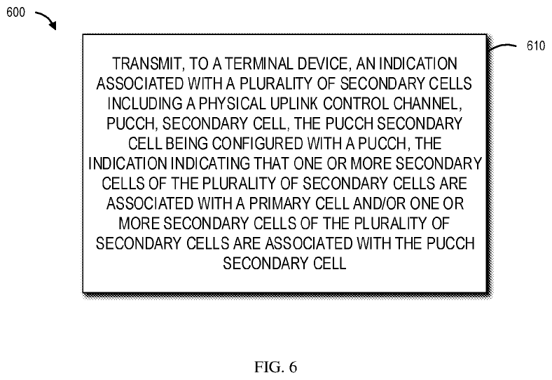

FIG. 6 shows a flowchart of an example method 600 according to some example embodiments of the present disclosure. The method 600 can be implemented by the device 220 as shown in FIG. 2. For the purpose of discussion, the method 600 will be described with reference to FIG. 2.

As shown in FIG. 6, at block 610, the device 220 transmits to the terminal device 210, an indication associated with a plurality of secondary cells including a physical uplink control channel, PUCCH, secondary cell, the PUCCH secondary cell being configured with a PUCCH, the indication indicating that one or more secondary cells of the plurality of secondary cells are associated with a primary cell and/or one or more secondary cells of the plurality of secondary cells are associated with the PUCCH secondary cell.

In some example embodiments, the indication may comprise an instruction to activate the plurality of secondary cells.

All operations and features as described above with reference to FIGS. 2-4 are likewise applicable to the method 600 and have similar effects. For the purpose of simplification, the details will be omitted.

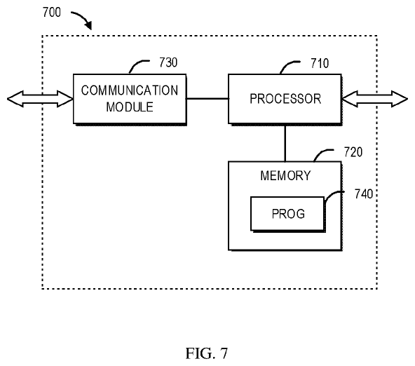

FIG. 7 is a simplified block diagram of a device 700 that is suitable for implementing example embodiments of the present disclosure. The device 700 can be implemented at or as a part of the device 210 or the device 220 as shown in FIG. 2.

As shown, the device 700 includes a processor 710, a memory 720 coupled to the processor 710, a communication module 730 coupled to the processor 710, and a communication interface (not shown) coupled to the communication module 730. The memory 720 stores at least a program 740. The communication module 730 is for bidirectional communications, for example, via multiple antennas. The communication interface may represent any interface that is necessary for communication.

The program 740 is assumed to include program instructions that, when executed by the associated processor 710, enable the device 700 to operate in accordance with the example embodiments of the present disclosure, as discussed herein with reference to FIGS. 2-6. The example embodiments herein may be implemented by computer software executable by the processor 710 of the device 700, or by hardware, or by a combination of software and hardware. The processor 710 may be configured to implement various example embodiments of the present disclosure.

The memory 720 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

When the device 700 acts as the device 210 or a part of the device 210, the processor 710 and the communication module 730 may cooperate to implement the method 500 as described above with reference to FIG. 5. When the device 700 acts as the device 220 or a part of the device 220, the processor 710 and the communication module 730 may cooperate to implement the method 600 as described above with reference to FIG. 6. All operations and features as described above with reference to FIGS. 2-6 are likewise applicable to the device 700 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 500 or 600 as described above with reference to FIGS. 5-6. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a method comprises: at a terminal device, receiving, from a network device, an instruction to activate a plurality of secondary cells including a physical uplink control channel, PUCCH, secondary cell, the PUCCH secondary cell being configured with a PUCCH; determining, from within the plurality of secondary cells, one or more secondary cells associated with a primary cell and one or more secondary cells associated with the PUCCH secondary cell; and prioritizing activation of the one or more secondary cells associated with the primary cell over activation of the one or more secondary cells associated with the PUCCH secondary cell.

In some example embodiments, the method further comprises: determining that cell detection is required for activating the one or more secondary cells associated with the primary cell and the one or more secondary cells associated with the PUCCH secondary cell.

In some example embodiments, the method further comprises: determining that one secondary cell is associated with the primary cell based on at least one of: a determination that the secondary cell is in the same timing advance group as the primary cell; a determination that channel state information reporting resources for the secondary cell are configured on the primary cell; an indication from a network device indicating that the secondary cell is associated with the primary cell; a determination that the secondary cell is collocated with the primary cell; or a determination that the secondary cell is intra-band with the primary cell based on a carrier aggregation configuration.

In some example embodiments, in accordance with a determination that the secondary cell is associated with the primary cell, the uplink transmission for the secondary cell will be transmitted on the primary cell after the secondary cell is activated.

In some example embodiments, the method further comprises: determining that one secondary cell is associated with the PUCCH secondary cell based on at least one of: a determination that the secondary cell is in the same timing advance group as the PUCCH secondary cell; a determination that channel state information reporting resources for the secondary cell are configured on the PUCCH secondary cell; an indication from a network device indicating that the secondary cell is associated with the PUCCH secondary cell; a determination that the secondary cell is collocated with the PUCCH secondary cell; or a determination that the secondary cell is intra-band with the PUCCH secondary cell based on a carrier aggregation configuration.

In some example embodiments, in accordance with a determination that the secondary cell is determined to be associated with the PUCCH secondary cell, uplink transmission for the secondary cell will be transmitted on the PUCCH secondary cell after the secondary cell is activated.

In some example embodiments, the method further comprises: prioritizing activation of the PUCCH secondary cell over the activation of the one or more secondary cells associated with the primary cell.

In some example embodiments, the method further comprises: prioritizing the activation of the one or more secondary cells associated with the primary cell over activation of the PUCCH secondary cell; and prioritizing the activation of the PUCCH secondary cell over the activation of the one or more secondary cells associated with the PUCCH secondary cell.

In some example embodiments, an activation delay for activating the one or more secondary cells associated with the primary cell is only based on the number of the one or more secondary cells associated with the primary cell; and an activation delay for activating the one or more secondary cells associated with the PUCCH secondary cell is based on: the number of the one or more secondary cells associated with the primary cell, and the number of the one or more secondary cells associated with the PUCCH secondary cell, and an activation delay for activating the PUCCH secondary cell.

In some aspects, a method comprises: at a network device, transmitting, to a terminal device, an indication associated with a plurality of secondary cells including a physical uplink control channel, PUCCH, secondary cell, the PUCCH secondary cell being configured with a PUCCH, the indication indicating that one or more secondary cells of the plurality of secondary cells are associated with a primary cell and/or one or more secondary cells of the plurality of secondary cells are associated with the PUCCH secondary cell.

In some example embodiments, the indication comprises an instruction to activate the plurality of secondary cells.

In some aspects, a terminal device comprises: at least one processor; and at least one memory including computer program code; the at least one memory and the computer program code configured to, with the at least one processor, cause the terminal device to: receive, from a network device, an instruction to activate a plurality of secondary cells including a physical uplink control channel, PUCCH, secondary cell, the PUCCH secondary cell being configured with a PUCCH; determine, from within the plurality of secondary cells, one or more secondary cells associated with a primary cell and one or more secondary cells associated with the PUCCH secondary cell; and prioritize activation of the one or more secondary cells associated with the primary cell over activation of the one or more secondary cells associated with the PUCCH secondary cell.

In some example embodiments, the terminal device is further caused to: determine that cell detection is required for activating the one or more secondary cells associated with the primary cell and the one or more secondary cells associated with the PUCCH secondary cell.

In some example embodiments, the terminal device is further caused to: determine that one secondary cell is associated with the primary cell based on at least one of: a determination that the secondary cell is in the same timing advance group as the primary cell; a determination that channel state information reporting resources for the secondary cell are configured on the primary cell; an indication from a network device indicating that the secondary cell is associated with the primary cell; a determination that the secondary cell is collocated with the primary cell; or a determination that the secondary cell is intra-band with the primary cell based on a carrier aggregation configuration.

In some example embodiments, in accordance with a determination that the secondary cell is associated with the primary cell, the uplink transmission for the secondary cell will be transmitted on the primary cell after the secondary cell is activated.

In some example embodiments, the terminal device is further caused to: determine that one secondary cell is associated with the PUCCH secondary cell based on at least one of: a determination that the secondary cell is in the same timing advance group as the PUCCH secondary cell; a determination that channel state information reporting resources for the secondary cell are configured on the PUCCH secondary cell; an indication from a network device indicating that the secondary cell is associated with the PUCCH secondary cell; a determination that the secondary cell is collocated with the PUCCH secondary cell; or a determination that the secondary cell is intra-band with the PUCCH secondary cell based on a carrier aggregation configuration.

In some example embodiments, in accordance with a determination that the secondary cell is determined to be associated with the PUCCH secondary cell, uplink transmission for the secondary cell will be transmitted on the PUCCH secondary cell after the secondary cell is activated.

In some example embodiments, the terminal device is further caused to: prioritize activation of the PUCCH secondary cell over the activation of the one or more secondary cells associated with the primary cell.

In some example embodiments, the terminal device is further caused to: prioritize the activation of the one or more secondary cells associated with the primary cell over activation of the PUCCH secondary cell; and prioritize the activation of the PUCCH secondary cell over the activation of the one or more secondary cells associated with the PUCCH secondary cell.

In some example embodiments, an activation delay for activating the one or more secondary cells associated with the primary cell is only based on the number of the one or more secondary cells associated with the primary cell; and an activation delay for activating the one or more secondary cells associated with the PUCCH secondary cell is based on: the number of the one or more secondary cells associated with the primary cell, and the number of the one or more secondary cells associated with the PUCCH secondary cell, and an activation delay for activating the PUCCH secondary cell.

In some aspects, an apparatus comprises: means for receiving, from a network device, an instruction to activate a plurality of secondary cells including a physical uplink control channel, PUCCH, secondary cell, the PUCCH secondary cell being configured with a PUCCH; means for determining, from within the plurality of secondary cells, one or more secondary cells associated with a primary cell and one or more secondary cells associated with the PUCCH secondary cell; and means for prioritizing activation of the one or more secondary cells associated with the primary cell over activation of the one or more secondary cells associated with the PUCCH secondary cell.

In some example embodiments, the apparatus further comprises: means for determining that cell detection is required for activating the one or more secondary cells associated with the primary cell and the one or more secondary cells associated with the PUCCH secondary cell.

In some example embodiments, the apparatus further comprises: means for determining that one secondary cell is associated with the primary cell based on at least one of: a determination that the secondary cell is in the same timing advance group as the primary cell; a determination that channel state information reporting resources for the secondary cell are configured on the primary cell; an indication from a network device indicating that the secondary cell is associated with the primary cell; a determination that the secondary cell is collocated with the primary cell; or a determination that the secondary cell is intra-band with the primary cell based on a carrier aggregation configuration.

In some example embodiments, in accordance with a determination that the secondary cell is associated with the primary cell, the uplink transmission for the secondary cell will be transmitted on the primary cell after the secondary cell is activated.

In some example embodiments, the apparatus further comprises: means for determining that one secondary cell is associated with the PUCCH secondary cell based on at least one of: a determination that the secondary cell is in the same timing advance group as the PUCCH secondary cell; a determination that channel state information reporting resources for the secondary cell are configured on the PUCCH secondary cell; an indication from a network device indicating that the secondary cell is associated with the PUCCH secondary cell; a determination that the secondary cell is collocated with the PUCCH secondary cell; or a determination that the secondary cell is intra-band with the PUCCH secondary cell based on a carrier aggregation configuration.

In some example embodiments, in accordance with a determination that the secondary cell is determined to be associated with the PUCCH secondary cell, uplink transmission for the secondary cell will be transmitted on the PUCCH secondary cell after the secondary cell is activated.

In some example embodiments, the apparatus further comprises: means for prioritizing activation of the PUCCH secondary cell over the activation of the one or more secondary cells associated with the primary cell.

In some example embodiments, the apparatus further comprises: means for prioritizing the activation of the one or more secondary cells associated with the primary cell over activation of the PUCCH secondary cell; and means for prioritizing the activation of the PUCCH secondary cell over the activation of the one or more secondary cells associated with the PUCCH secondary cell.

In some example embodiments, an activation delay for activating the one or more secondary cells associated with the primary cell is only based on the number of the one or more secondary cells associated with the primary cell; and an activation delay for activating the one or more secondary cells associated with the PUCCH secondary cell is based on: the number of the one or more secondary cells associated with the primary cell, and the number of the one or more secondary cells associated with the PUCCH secondary cell, and an activation delay for activating the PUCCH secondary cell.

In some aspects, an apparatus comprises: means for transmitting, to a terminal device, an indication associated with a plurality of secondary cells including a physical uplink control channel, PUCCH, secondary cell, the PUCCH secondary cell being configured with a PUCCH, the indication indicating that one or more secondary cells of the plurality of secondary cells are associated with a primary cell and/or one or more secondary cells of the plurality of secondary cells are associated with the PUCCH secondary cell.

In some example embodiments, the indication comprises an instruction to activate the plurality of secondary cells.

In some aspects, a computer readable storage medium comprises program instructions stored thereon, the instructions, when executed by a processor of a device, causing the device to perform the method according to some example embodiments of the present disclosure.

1. A terminal device, comprising:
at least one processor; and
at least one memory including computer program code;
the at least one memory and the computer program code configured to, with the at least one processor, cause the terminal device to:
receive, from a network device, an instruction to activate a plurality of secondary cells including a physical uplink control channel, PUCCH, secondary cell, the PUCCH secondary cell being configured with a PUCCH;
determine, from within the plurality of secondary cells, one or more secondary cells associated with a primary cell and one or more secondary cells associated with the PUCCH secondary cell; and
prioritize activation of the one or more secondary cells associated with the primary cell over activation of the one or more secondary cells associated with the PUCCH secondary cell.

2. The terminal device of claim 1, wherein the terminal device is further caused to:
determine that cell detection is required for activating the one or more secondary cells associated with the primary cell and the one or more secondary cells associated with the PUCCH secondary cell.

3. The terminal device of claim 1, wherein the terminal device is further caused to:
determine that one secondary cell is associated with the primary cell based on at least one of:
a determination that the secondary cell is in the same timing advance group as the primary cell;
a determination that channel state information reporting resources for the secondary cell are configured on the primary cell;
an indication from a network device indicating that the secondary cell is associated with the primary cell;
a determination that the secondary cell is collocated with the primary cell; or
a determination that the secondary cell is intra-band with the primary cell based on a carrier aggregation configuration.

4. The terminal device of claim 3, wherein in accordance with a determination that the secondary cell is associated with the primary cell, the uplink transmission for the secondary cell will be transmitted on the primary cell after the secondary cell is activated.

5. The terminal device of claim 1, wherein the terminal device is further caused to:
determine that one secondary cell is associated with the PUCCH secondary cell based on at least one of:
a determination that the secondary cell is in the same timing advance group as the PUCCH secondary cell;
a determination that channel state information reporting resources for the secondary cell are configured on the PUCCH secondary cell;
an indication from a network device indicating that the secondary cell is associated with the PUCCH secondary cell;
a determination that the secondary cell is collocated with the PUCCH secondary cell; or
a determination that the secondary cell is intra-band with the PUCCH secondary cell based on a carrier aggregation configuration.

6. The terminal device of claim 5, wherein in accordance with a determination that the secondary cell is determined to be associated with the PUCCH secondary cell, uplink transmission for the secondary cell will be transmitted on the PUCCH secondary cell after the secondary cell is activated.

7. The terminal device of claim 1, wherein the terminal device is further caused to:
prioritize activation of the PUCCH secondary cell over the activation of the one or more secondary cells associated with the primary cell.

8. The terminal device of claim 1, wherein the terminal device is further caused to:
prioritize the activation of the one or more secondary cells associated with the primary cell over activation of the PUCCH secondary cell; and
prioritize the activation of the PUCCH secondary cell over the activation of the one or more secondary cells associated with the PUCCH secondary cell.

9. The terminal device of claim 1, wherein:
an activation delay for activating the one or more secondary cells associated with the primary cell is only based on the number of the one or more secondary cells associated with the primary cell; and
an activation delay for activating the one or more secondary cells associated with the PUCCH secondary cell is based on: the number of the one or more secondary cells associated with the primary cell, and the number of the one or more secondary cells associated with the PUCCH secondary cell, and an activation delay for activating the PUCCH secondary cell.

10. A network device, comprising:
at least one processor; and
at least one memory including computer program code;
the at least one memory and the computer program code configured to, with the at least one processor, cause the network device to:
transmit, to a terminal device, an indication associated with a plurality of secondary cells including a physical uplink control channel, PUCCH, secondary cell, the PUCCH secondary cell being configured with a PUCCH, the indication indicating that one or more secondary cells of the plurality of secondary cells are associated with a primary cell and/or one or more secondary cells of the plurality of secondary cells are associated with the PUCCH secondary cell.

11. The network device of claim 10, wherein the indication comprises an instruction to activate the plurality of secondary cells.

12. A method comprising:
at a terminal device,
receiving, from a network device, an instruction to activate a plurality of secondary cells including a physical uplink control channel, PUCCH, secondary cell, the PUCCH secondary cell being configured with a PUCCH;
determining, from within the plurality of secondary cells, one or more secondary cells associated with a primary cell and one or more secondary cells associated with the PUCCH secondary cell; and
prioritizing activation of the one or more secondary cells associated with the primary cell over activation of the one or more secondary cells associated with the PUCCH secondary cell.

13. The method of claim 12, further comprising:
determining that cell detection is required for activating the one or more secondary cells associated with the primary cell and the one or more secondary cells associated with the PUCCH secondary cell.

14. The method of claim 12, further comprising:
determining that one secondary cell is associated with the primary cell based on at least one of:
a determination that the secondary cell is in the same timing advance group as the primary cell;
a determination that channel state information reporting resources for the secondary cell are configured on the primary cell;
an indication from a network device indicating that the secondary cell is associated with the primary cell;
a determination that the secondary cell is collocated with the primary cell; or
a determination that the secondary cell is intra-band with the primary cell based on a carrier aggregation configuration.

15. The method of claim 14, wherein in accordance with a determination that the secondary cell is associated with the primary cell, the uplink transmission for the secondary cell will be transmitted on the primary cell after the secondary cell is activated.

16. The method of claim 12, further comprising:
determining that one secondary cell is associated with the PUCCH secondary cell based on at least one of:
a determination that the secondary cell is in the same timing advance group as the PUCCH secondary cell;
a determination that channel state information reporting resources for the secondary cell are configured on the PUCCH secondary cell;
an indication from a network device indicating that the secondary cell is associated with the PUCCH secondary cell;
a determination that the secondary cell is collocated with the PUCCH secondary cell; or
a determination that the secondary cell is intra-band with the PUCCH secondary cell based on a carrier aggregation configuration.

17. The method of claim 16, wherein in accordance with a determination that the secondary cell is determined to be associated with the PUCCH secondary cell, uplink transmission for the secondary cell will be transmitted on the PUCCH secondary cell after the secondary cell is activated.

18. The method of claim 12, further comprising:
prioritizing activation of the PUCCH secondary cell over the activation of the one or more secondary cells associated with the primary cell.

19. The method of claim 12, further comprising:
prioritizing the activation of the one or more secondary cells associated with the primary cell over activation of the PUCCH secondary cell; and
prioritizing the activation of the PUCCH secondary cell over the activation of the one or more secondary cells associated with the PUCCH secondary cell.

20. The method of claim 12, wherein:
an activation delay for activating the one or more secondary cells associated with the primary cell is only based on the number of the one or more secondary cells associated with the primary cell; and
an activation delay for activating the one or more secondary cells associated with the PUCCH secondary cell is based on: the number of the one or more secondary cells associated with the primary cell, and the number of the one or more secondary cells associated with the PUCCH secondary cell, and an activation delay for activating the PUCCH secondary cell.

21-25. (canceled)
